(19) United States
(12) Patent Application Publication
(10) Pub. No.: US 2016/0242434 A1
(43) Pub. Date: Aug. 25, 2016

(54) Fro-Style Flavor System

(71) Applicant: Robofusion, Inc., Charleston, SC (US)

(72) Inventors: Allan Jones, Charleston, SC (US); Or Kroub, Charleston, SC (US); James Wolf, Silver Lake, OH (US)

(73) Assignee: Robofusion, Inc., Charleston, SC (US)

(21) Appl. No.: 15/050,992

(22) Filed: Feb. 23, 2016

Related U.S. Application Data
(60) Provisional application No. 62/119,942, filed on Feb. 24, 2015.

(51) Int. Cl. A23G 9/04; G07F 13/10; G07F 17/00

(52) U.S. Cl. CPC A23G 9/04; G07F 17/0071; G07F 13/10

(57) ABSTRACT

The present disclosure relates to a compact, automated food preparation and customization device.

### BACKGROUND OF THE INVENTION

1) Field of the Invention

The present disclosure relates to a compact, automated food preparation and customization device.

2) Description of Related Art

Automated machines for dispensing ice cream and other frozen treats are known in the art. For example, Chirnomas (U.S. Pat. No. 5,027,698) discloses an ice cream vending machine wherein the machine dispenses pre-filled containers of ice cream. Davis et al. (U.S. Patent Application Publication No. 2004/0251270) describes an ice cream dispensing machine for dispensing soft-serve ice cream. Kateman et al. (U.S. Pat. No. 7,052,728) describes a machine for vending single servings of different flavors wherein selected flavorants are mixed into a base liquid prior to freezing.

These and other automated vending devices do not provide the customer an enhanced purchase occasion in that the process of preparing and conveying the selected product is generally invisible to the customer. Alcaraz et al. (U.S. Pat. No. 4,889,210) describes a robotic vending machine. However, in the Alcaraz patent, the dispensing process is limited to transferring pre-packaged items to the customer or to placing single items (such as a beverage) into a container. Prior concepts by the current inventors, Jones et al. (U.S. Pat. No. 7,896,038), Jones et al. (U.S. Pat. Pub. No. 2011/0108569), and Jones et al. (U.S. Pat. Pub. No. 2014/0120235), disclose confectionary vending machines with portions of the inner workings visible to the user with some incorporating robotic actors. However, these disclosures do not provide sufficient customization choices to consumers. Therefore, a better way of dispensing edible items is needed.

Accordingly, it is an object of the present disclosure to provide a fully automated, compact food preparation and customization device that gives the consumer not only more choices in how to combine and customize food stuffs but also provides a visual enhancement as the consumer may watch the item being prepared as the customer directed.

### BRIEF DESCRIPTION OF THE DRAWINGS

The construction designed to carry out the disclosure will hereinafter be described, together with other features thereof. The disclosure will be more readily understood from a reading of the following specification and by reference to the accompanying drawings forming a part thereof, wherein an example of the disclosure is shown and wherein:

FIG. 1 is a flow chart showing one possible customer interaction with a dispensing device of the current disclosure.

FIG. 2 illustrates one possible embodiment of product customization options offered to a consumer.

FIG. 3 shows a downward perspective view of a dispensing device of one embodiment of the current disclosure.

FIG. 3A illustrates a tilted front view of a dispensing device per one embodiment of the present disclosure.

FIG. 4 is an upward perspective, tilted view of one embodiment of a dispensing device of the present disclosure.

FIG. 5 illustrates a flavor container as described in one embodiment.

FIG. 6 illustrates a robotic arm for one embodiment of the disclosure.

FIG. 7 illustrates one embodiment of a user interface for the present disclosure.

FIG. 8 illustrates a door facing for one embodiment of a dispensing device of the current disclosure.

FIG. 9 is a rear view of one embodiment of a dispensing device of the current disclosure.

FIG. 9A is a front, cut away view of one embodiment of a dispensing device of the current disclosure.

FIG. 9B is a close up view of one embodiment of a blend head assembly of the current disclosure.

FIG. 10 illustrates an ingredient assembly of the present invention.

FIG. 11 illustrates a pump assembly of the present disclosure.

FIG. 12 illustrates a partially disassembled blend head assembly of the present disclosure.

FIG. 13 illustrates an assembled blend head assembly of the present disclosure.

It will be understood by those skilled in the art that one or more aspects of this disclosure can meet certain objectives, while one or more other aspects can meet certain other objectives. Each objective may not apply equally, in all its respects, to every aspect of this disclosure. As such, the preceding objects can be viewed in the alternative with respect to any one aspect of this disclosure. These and other objects and features of the disclosure will become more fully apparent when the following detailed description is read in conjunction with the accompanying figures and examples. However, it is to be understood that both the foregoing summary of the disclosure and the following detailed description are of a preferred embodiment and not restrictive of the disclosure or other alternate embodiments of the disclosure. In particular, while the disclosure is described herein with reference to a number of specific embodiments, it will be appreciated that the description is illustrative of the disclosure and is not constructed as limiting of the disclosure. Various modifications and applications may occur to those who are skilled in the art, without departing from the spirit and the scope of the disclosure, as described by the appended claims. Likewise, other objects, features, benefits and advantages of the present disclosure will be apparent from this summary and certain embodiments described below, and will be readily apparent to those skilled in the art. Such objects, features, benefits and advantages will be apparent from the above in conjunction with the accompanying examples, data, figures and all reasonable inferences to be drawn therefrom, alone or with consideration of the references incorporated herein.

### DETAILED DESCRIPTION OF A PREFERRED EMBODIMENT

With reference to the drawings, the disclosure will now be described in more detail. Unless defined otherwise, all technical and scientific terms used herein have the same meaning as commonly understood to one of ordinary skill in the art to which the presently disclosed subject matter belongs. Although any methods, devices, and materials similar or equivalent to those described herein can be used in the practice or testing of the presently disclosed subject matter, representative methods, devices, and materials are herein described.

Previous disclosures provide the choice of one two choices of frozen yogurt and, possibly, providing a “twist” combination of the two flavors. The current disclosure allows for many flavors, even greater than fifteen, that may be layered or blended. In the case of blending, this entails creating new flavors of frozen yogurt by blending multiple flavors which was previously completely unavailable.

In one embodiment of the current disclosure, a compact customizable food dispenser is provided. In a further embodiment, the dispenser may utilize from 8 to 20 square feet of space, in a more preferred embodiment from 10 to 16 square feet of space, and in a more preferred embodiment the dispenser may occupy only 12 square feet of floor space. In a further embodiment, the dispenser may be fully automated. In a still further embodiment, the dispenser may deliver up to 60 servings per hour of customized food items. In a still further embodiment, customers may layer or blend various flavors and choose from various toppings. In a still further embodiment, each flavor may have its own pump. In a still further embodiment, operation of these pumps, for example by turning some off and others on, may create a layered food item. In a further embodiment, various pumps may be ran simultaneously to produce blended food items containing at least two flavors.

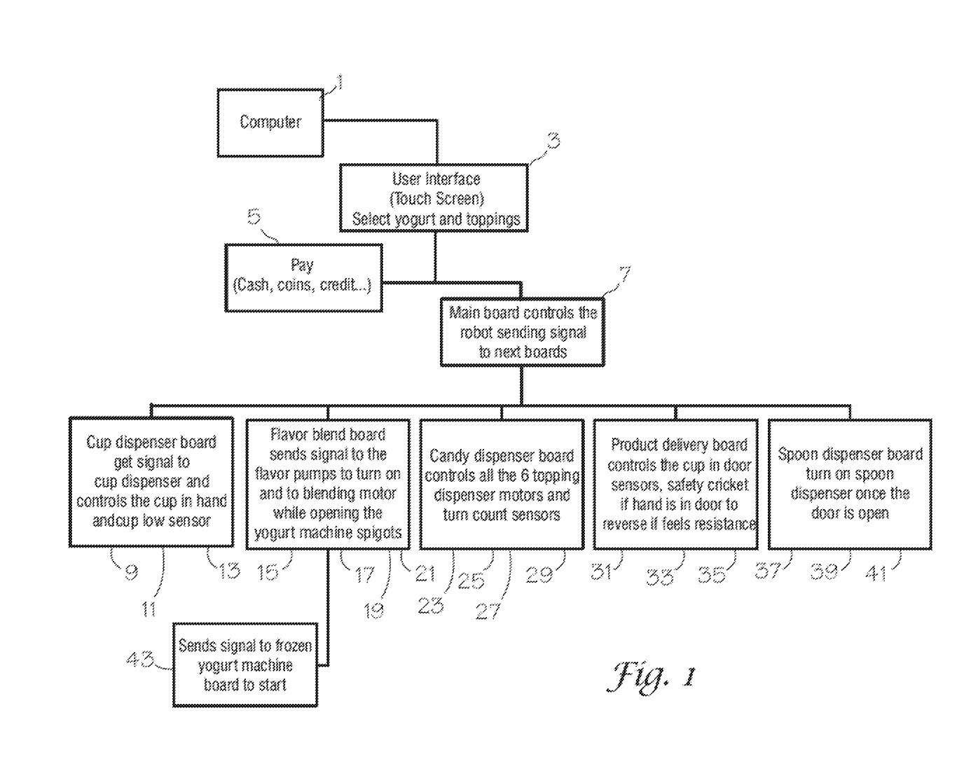

FIG. 1 illustrates a flow chart of one embodiment of the current disclosure with respect to a yogurt dispensing device. A computer 1 may be incorporated into the dispenser in addition to one or more user interfaces 3. The user interfaces may be touchscreens or other means known to those of skill in the art for allowing a consumer to communicate with the dispenser such as a button-pad, a voice activated system, or a system configured to work with a smart phone or other device. User interface 3 may allow the consumer to select the type of food to be conveyed by the dispenser. In a preferred embodiment, the food may be a yogurt, with or without toppings. The dispenser may also include means for accepting payment 5 from a consumer such as a credit card swipe, a coin or bill slot, or other means of payment transfer as known to those of skill in the art. The dispenser may also include a main board 7 which may control the dispensing means for providing the food. The dispensing means may include items such as robotic characters, a robotic armature, or other ways of entertaining a consumer as they watch their food being prepared. Main board 7 controls the dispensing means and may send signals to other boards located in the dispenser.

For instance, a cup dispenser board 9 may receive a signal from main board 7 and cup dispenser board 9 may control the dispenser 11 as well as communicate with a cup low sensor 13. A flavor blend board 15 may signal flavor pumps 17 and blending motor 19 to initiate while opening yogurt spigots 21. A topping dispenser board 23, such as for dispensing candy toppings like sprinkles, jelly beans, gummy bears, etc., as known to those of skill in the art, may control multiple topping dispensers 25, FIG. 1 discusses six (6) dispensers but this disclosure is not so limited and more or less dispensers are considered within the scope of this disclosure. Topping dispenser board 23 may communicate with dispenser motors 27 as well as activate count sensors 29 to determine the amount of toppings being dispersed. A product delivery board 31 may control a cup-in-door sensor 33. The product delivery board 31 may also communicate with safety device 35 that may warn the customer if their hand is blocking delivery or they are otherwise impeding operation of the device or may be harmed by continued activity. Indeed, safety device 35 may communicate with delivery board 31 such that product delivery is halted or reversed until the safety alert condition is remedied. A spoon dispenser board 37 may also be employed in the device to dispense a spoon 39 once door 41 is open. The dispenser may also signal a frozen yogurt machine board 43.

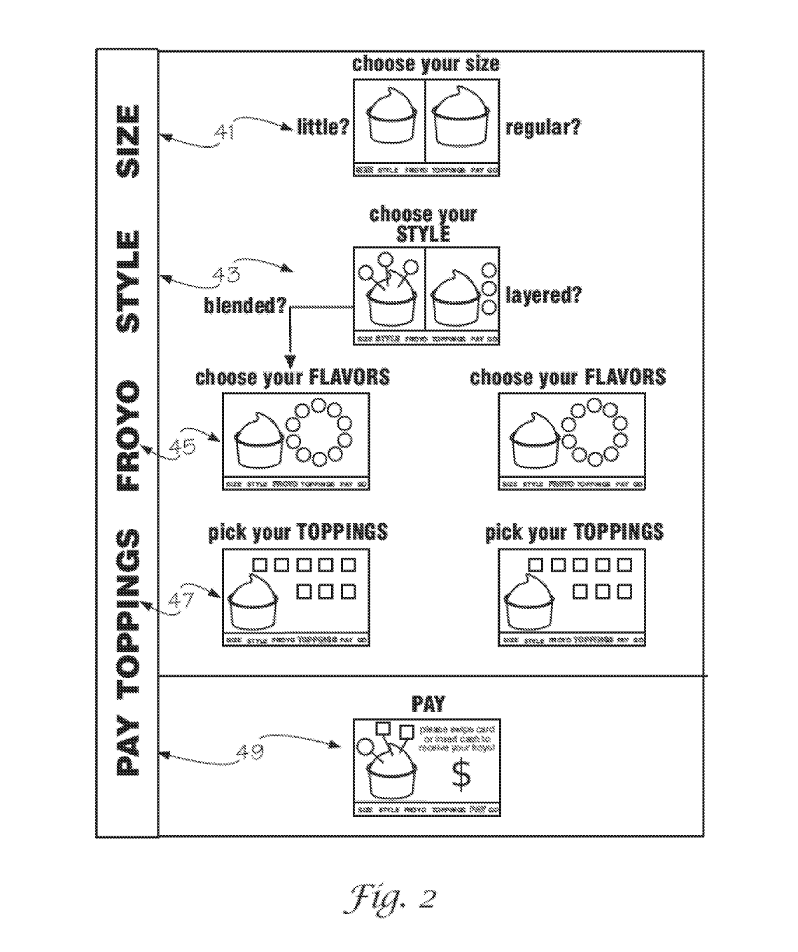

One improvement provided by the current disclosure is the ability for consumers to customize the product they receive. Returning to the example of the dispenser providing frozen yogurt, customers may select how their products will be mixed. FIG. 2 illustrates the selections offered to a customer. At a first step 41, the customer may choose the size of their confection. For instance, the confection may be small or large. Indeed, various confection sizes may be offered and labeled in ways to entice various customers to consistently select certain sizes, such as a “fitness conscious” person selecting a “very small” option whereas children may opt for “ginormous large.” While only little and regular size options are shown in FIG. 2, multiple size configurations such as 3, 4, 5, 6, or more, are within the scope of this disclosure, including half sizes of any selected size. At step 43, the customer may select whether their yogurt is blended, layered, or a combination of layered and blended yogurts. This choice of options is currently unavailable in automated confection dispensing systems. By selecting blended, the customer may receive a confection where two or more flavors are simultaneously released into a blending chamber (not shown) by activating two or more flavor pumps (not shown) and then transferred to the customer's cup (not shown). Conversely, by selecting layers, the customer receives a confection where pumps are alternatively activated such that flavors are introduced into the cup one at a time to form a layered confection, for purposes of clarification only, such as having the appearance of Neapolitan ice cream where the layers of ice cream are visually discernable from one another.

Continuing with FIG. 2, at step 45, once the customer selects blended or layered, he may then choose the flavor(s) of yogurt. One or more flavors are possible. Further, with the blending option, combinations of flavors are available to the customer that do not exist separately such as for purposes of example only, vanilla/strawberry. At step 47, the customer may choose the toppings introduce to their yogurt. One or more topping selections are available. At step 49, the customer may pay for the yogurt and toppings they have selected. By having the payment stage occur last in the customization scheme, the customers may pay variable amounts, such as more than some customers but less than other customers for their confection based on the flavors and toppings selected. For example, someone electing only one flavor and one topping may pay less than someone electing multiple flavors and multiple toppings but the customer with one flavor and one topping may pay more than a customer selecting only one flavor and no toppings. Thus, not only does the current disclosure allow for customization of the food product being delivered, it allows for variable pricing, which may entice cost conscious customers to try the dispenser when they might not have otherwise.

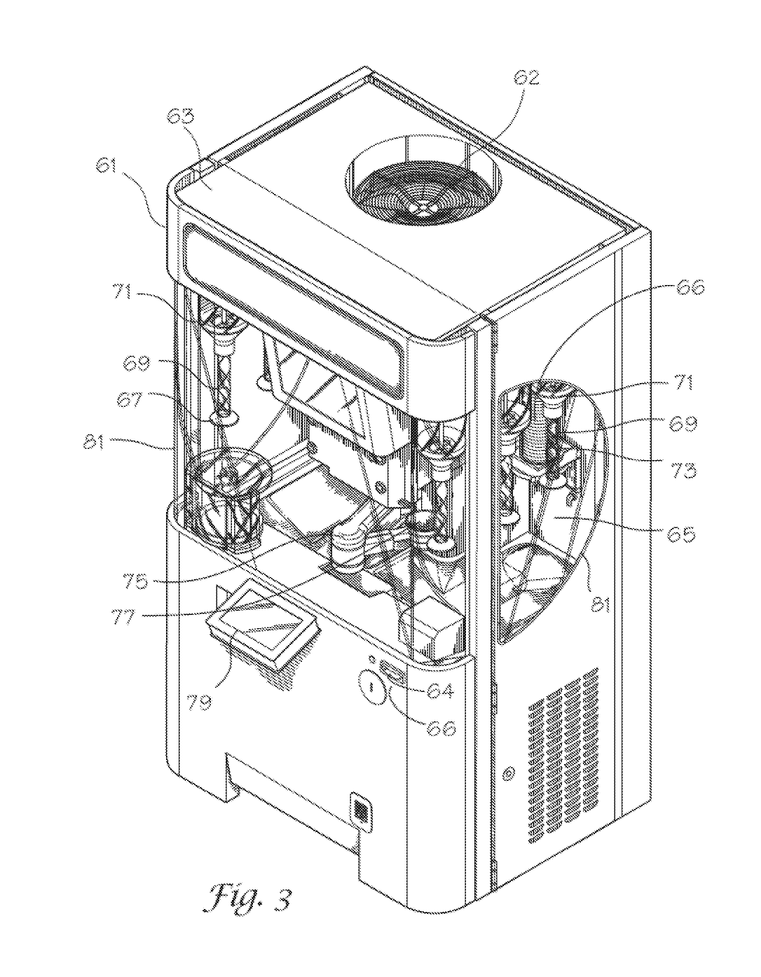

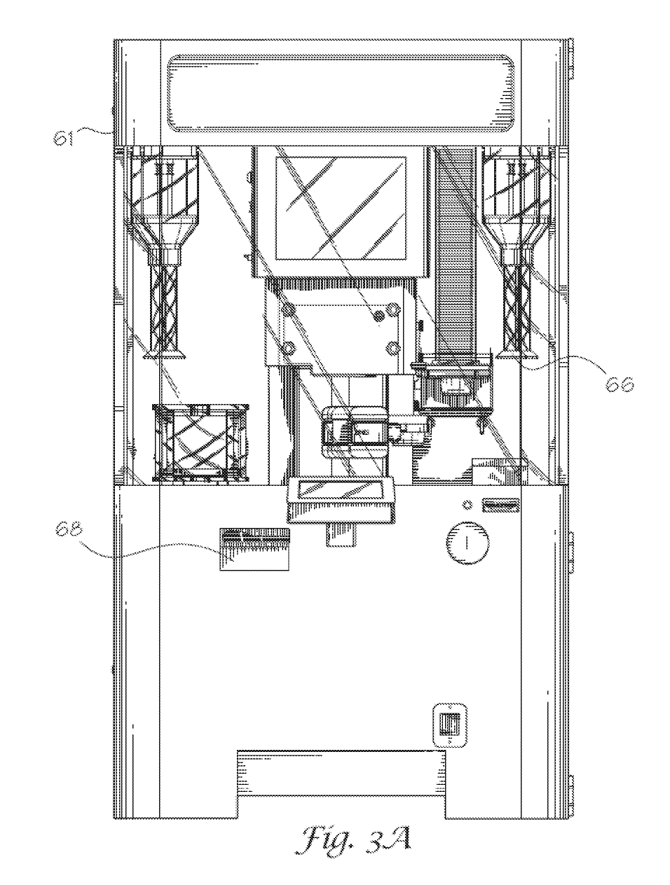

FIG. 3 shows a further embodiment of the disclosure, a confectionary dispensing device 61. Device 61 includes a housing 63, an interior 65 containing a dispensing station 67 for dispensing a measured amount of one or more flavors of a frozen confectionary, such as ice cream, sherbet, yogurt, gelato, custard and flavored or non-flavored ice, or any other food stuff or beverage that may be suitable for delivery from the dispensing device 61. A topping dispensing station 69 for dispensing a measured amount of topping, such as chocolate syrup, candies, nuts, etc., from a toppings container 71 via a topping delivery conductor 73, and a robotic transfer mechanism, such as a robotic arm 75, for moving a product receptacle 77, such as a cup, bowl or other form of container, for the frozen confectionary product to the various dispensing stations of device 61 according to specifications/selections enter by a customer or other user via a user interface 79.

Housing 63 includes one or more transparent viewing windows 81 to enable the user to view the confectionary product as it is being made. Toppings container 71 as well as topping delivery conductor 73 are also preferably transparent or translucent, which advantageously enables the customer to view the topping contained therein. In a preferred embodiment as shown in FIG. 3, dispensing device 61 includes a plurality of topping dispensing stations 67 and topping containers 71 may be transparent, and topping deliver conductors 73 may also be transparent, to enable the user to select and view the delivery of one or more toppings from a plurality of available toppings. Dispensing device 61 may also include a ventilation system 62. Ventilation system 62 may serve to not only cool dispensing device 61 but may also be used to entice customers to find the device by following the smell of the items it dispenses. Dispensing device 61 also includes payment means 64, which may include a credit card reader or means for accepting hard currency such as coins or bills, or may include a processor 66 to allow dispensing device 61 to communicate with handheld devices such as smartphones (not shown) or other electronic devices capable of conveying payment to dispensing device 61.

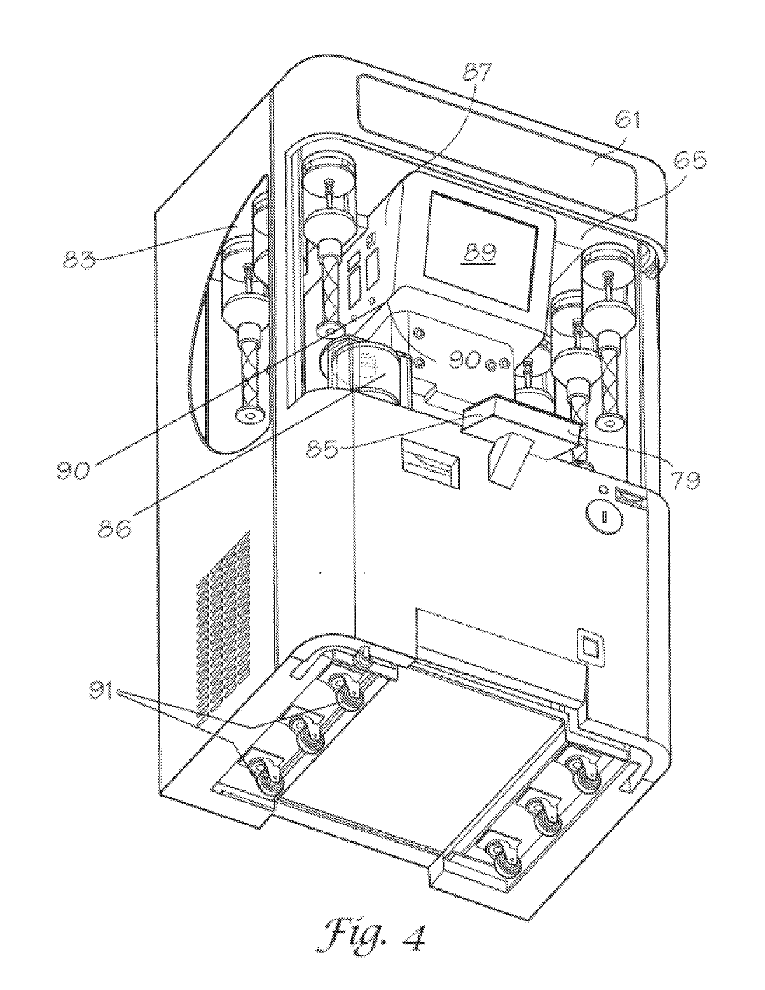

With respect to FIG. 4, dispensing device 61 may incorporate additional features, including but not limited to lights 83 that are controllable by an electronic processor 85 to flash, strobe, race, etc., bells, whistles, loudspeakers 68, internet access, seats, and computer games, all of which would be controllable by processor 85. Further, lights 83 may be used to hygienically sterilize interior 65 of dispensing device 61 through the use of UV or other light frequencies, as known to those of skill in the art. Dispensing device 61 may also include a video display 89. Display 89 may convey messages to consumers such as product sales or specials, new flavors or toppings, or use advertising to entice consumers to engage device 61. Display 89 may work in tandem with user interface 79 to allow consumers to communicate with dispensing device 61, or to play games, access the internet, or any other desired way of maintaining consumer interaction with the machine either during or separate from dispensing food from device 61. Display 89 may also be used as viewing screens for the consumer to choose and watch videos or images, select flavors, view possible combinations of flavors or flavors that may result from mixing existing flavors, see and/or obtain pricing information, etc.

Dispensing device 61 is preferably stationary during use. Mobility of device 61 may be enhanced by attaching casters, rollers or wheels 91 to the bottom of dispensing device 61. If desired, dispensing device 61 may be self-propelled or part of a self-propelled system (i.e., such as mounted on a vehicle) to further enhance mobility.

Interior 65 of dispensing device 61 is visually accessible to the consumer. Such visual access may be through transparent and/or translucent glass or viewing windows 81 or panel portions, through metal or wire grids or bars, or by any combination, including by video camera, sufficiently transparent or translucent panels, and/or by any other means that provides the customer with visual access to at least desired portions of the product assembly process. The consumer being able to view the confections being created provides visual and auditory enhancements that may entice further purchases from device 61 simply to “watch the show” of the goods being made.

FIG. 3A shows a tilted front view of dispensing device 61, as well as utensil dispenser 68. Utensil dispenser 68 may be activated by computer 90 to release a utensil for consuming the food product once product is delivered to delivery port 86. This arrangement may lead to a more hygienic food dispensing system as multiple consumers do not come into contact with multiple utensils. Instead, a single utensil is made available to the consumer once the product is delivered to delivery port 86.

Referring to FIGS. 3 and 4, user interface 79 is preferably positioned such that it can be comfortably and effectively operated by consumers. Access to user interface 79 may be enhanced by the presence and/or operation of stationary or retractable stairs, elevators, platforms, or any combination of these features. Such features may also be utilized by a user to increase visibility of the interior portion 65 of dispensing device 61 in order to enhance the vending occasion and/or experience.

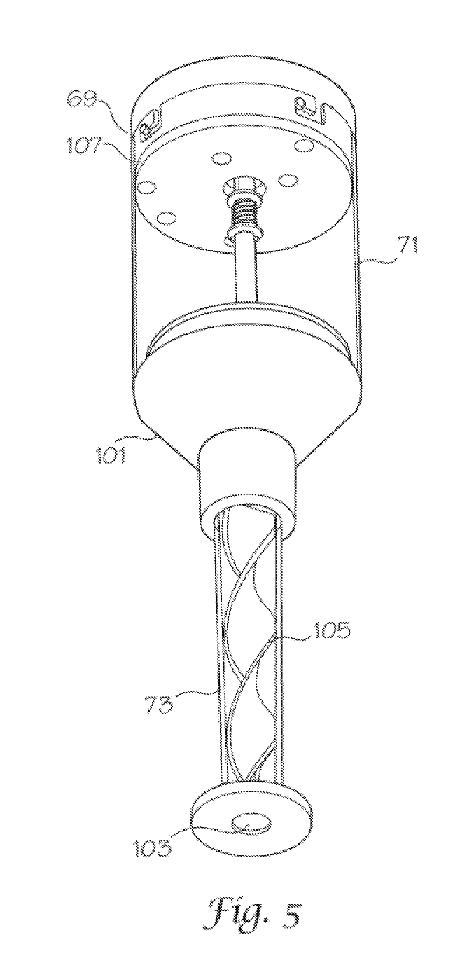

Referring to FIG. 5, topping delivery conductor 73 is preferably in the form of a transparent tube. However, it will be understood that any configuration of conductor 73 suitable for delivering a measured amount of topping from container 71 to a product receptacle may be used instead. Preferably, conductor 73 is constructed in such a manner that at least a portion of the transference of one or more toppings can be viewed by the customer during the delivery process by being translucent and/or transparent and/or otherwise visible. A single conductor 73 may be utilized to transfer a single topping or multiple toppings. Alternatively, a plurality of conductors can be used to transfer multiple toppings from multiple containers 71 into the product receptacle. Conductor 73 may have a funnel-shaped inlet 101 to help ensure effective delivery/transfer of the topping into the conductor 73 and an outlet 103 through which the topping is delivered into the product receptacle 77 (not shown).

With continued reference to FIG. 5, retarders 105 are preferably incorporated into conductor 73 to help retard/slow the flow of topping into the product receptacle 77 to prevent splashing or spilling of the topping. Retarder 105 may be in the form of bends, curves, baffles or other such structure which lengthen the amount of time it takes for the topping to travel through conductor 73. Retarders 105 may or may not be visually accessible in all embodiments, but are in a preferred embodiment. Retarders 105 of the type shown in FIG. 5 are also believed to enhance the user's viewing experience.

In addition to providing visual stimulus, the transference of any topping from container 71 may be accompanied by sounds, including sounds naturally made by the topping passing through conductor 73, or by artificially created sounds such as musical tunes, bells, whistles, alarms, etc. played through a speaker 87 (FIG. 4) that is operated by computer 90 (FIG. 4). Artificially created sounds may also arise from the interaction of one or more toppings with a secondary device such as a whirring, spinning wheel, flippers, ramps, carousel type dispensers, etc., as known to those of skill in the art.

Topping container 71 is preferably visually accessible (i.e., transparent) as illustrated. This is helpful in that it provides an attractive visual stimulus to customers as well as provides a quick way for a service technician to check the amount of topping remaining within container 71. In order to dispense toppings from container 71 to conductor 73, a preferred embodiment of device 61 employs a servo motor 107 or other force generating unit for dispensing a measured amount of toppings from the container 71 to conductor 73 upon receipt of instructions from an electronic processor such as a computer 90 (FIG. 4) in electronic communication with user interface 79 and servo motor, or other motor as known to those of skill in the art, 107. An auger (not shown) or other suitable structure may be driven by servo motor 107 to precisely dispense the measured amount of topping from container 71. Scooping mechanisms, valve based systems, or other dispensing arrangements, as known to those of skill in the art, may be employed in other embodiments to deliver toppings to the food item(s).

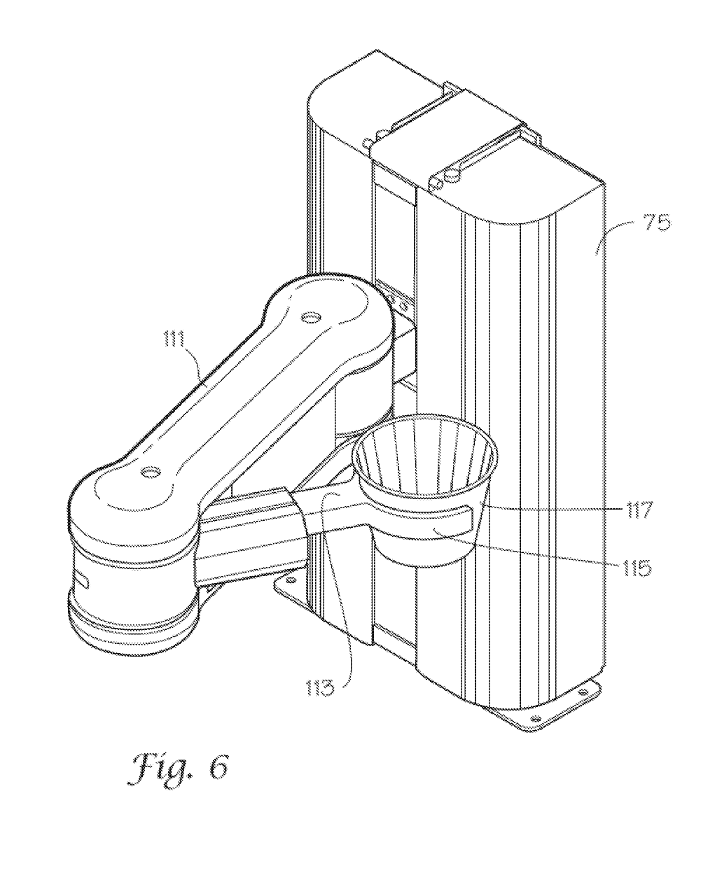

Referring to FIG. 6, robotic arm 75 may be constructed of any materials suitable for transferring the product receptacle to the various dispensing stations 69 and product delivery port 86 (FIG. 3). Movement of robotic arm 75 is preferably controlled by computer 90 that is programmed to move robotic arm 75 according to selections/instructions entered by the consumer through user interface 79. Alternatively, robotic arm 75 may be at least partially controlled or controllable by the consumer through user interface 79. More than one robotic aim 75 may be utilized as needed or desired.

Robotic arm 75 preferably has at least three axes of movement, which is largely enabled by the use of pivoting links 111, 113. More specifically, robotic arm 75 is capable of movement in a horizontal left-to-right dimension (x-axis), a horizontal front-to-back dimension (y-axis), and a vertical up-and-down dimension (z-axis), this includes diagonal movement as well. Gripper 115, which is used to grasp and hold product receptacle 117, is carried by robotic arm 75 as it moves in three dimensions. Other robotic transfer mechanisms may be utilized in conjunction with and/or in place of the robotic arm 75. Moreover, rotational movement, such as robotic arm 75 being able to “spin” receptacle 117 or being able to rotate receptacle 117 around the receptacle's y-axis are also considered part of the scope of this disclosure.

During one embodiment of a product assembly and delivery process, link 113 may be maintained in a constant horizontal attitude as robotic arm 75 moves in at least three dimensions so that the product receptacle 117, in this case an inedible cup, but edible containers are also considered within the scope of this disclosure, can be transported without spilling any of its contents. Receptacle 117 can be moved elevationally as well as horizontally over a significant left to right range, as well as forward and backward.

In one embodiment, an empty product receptacle or cup 117 has been removed from product receptacle dispenser 66 (FIG. 3), which preferably includes at least two types of products receptacles (such as an inedible container and an edible container) that are selectable by the user through the user interface 79. Receptacle 117 may be moved by robotic arm 75 between the various dispensing stations 67 including product receptacle dispensing station 66. Frozen confectionary product dispensing station 121 includes an outlet 123 for a frozen confectionary product dispenser shown generally at 125. Dispenser 125 is preferably configured to dispense one or more types and one or more flavors of frozen confectionary product. Preferably, the dispenser 125 can dispense at least three if not four or more flavors. The frozen confectionary products are preferably stored in a frozen or chilled condition in a cooler shown generally at 127. The particular types and/or flavors to be dispensed are preferably controlled by computer 90 through selections entered at user interface 79. Once receptacle 117 is at least partially filled with frozen confectionary, the product receptacle 117 is moved to topping dispensing station 67 and positioned below the outlet 103 of conductor 73. A signal is output by computer 90 to instruct servo motor 107 to dispense a measured amount of topping into the product receptacle 117 on top of at least a first layer of frozen confectionary. Alternatively, a topping may be dispensed into receptacle 117 before any frozen confectionary is dispensed. In addition, multiple toppings and/or confectionary products may be layered into receptacle 117 (i.e., a layer of frozen yogurt followed by a layer of chocolate syrup followed by a layer of ice cream, etc.) as dictated by customer selections entered through the user interface 79.

In an alternative embodiment, a mixing assembly, not shown, may be employed (such as with air or mechanical mixing/stirring devices) to assist in mixing the frozen confectionary and topping(s) in receptacle 117. Following assembly of the frozen confectionary product, receptacle 117 is moved to product delivery port 86 where it is received by the customer.

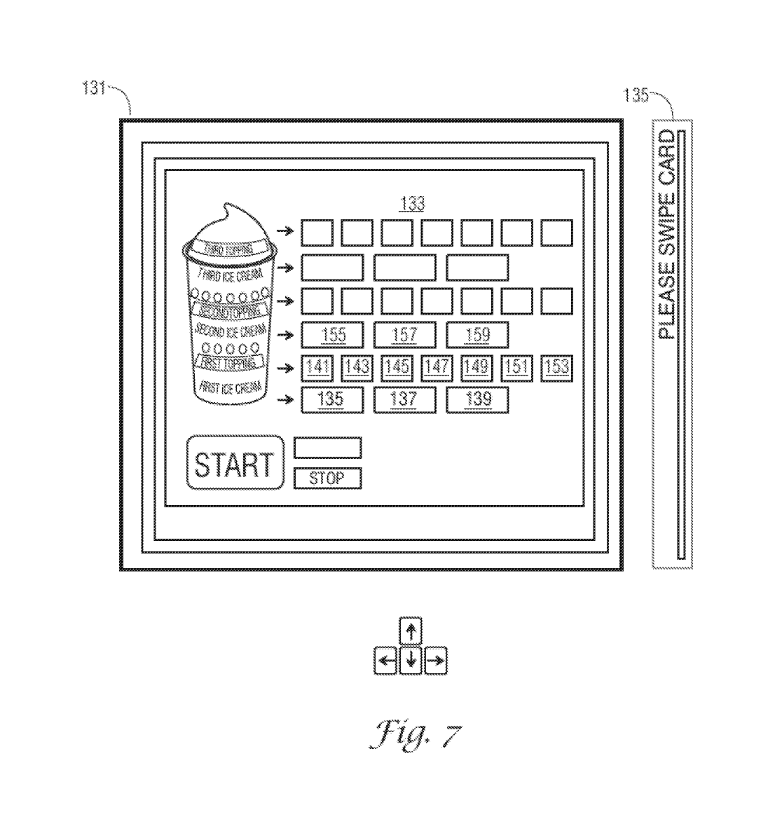

One embodiment of a user interface 131, shown in FIG. 7, includes a touch screen panel 133. Alternative forms of a user interface, such as keyboard, keypads, knobs, wheels, push buttons, switches, joysticks, etc., or combinations thereof, may be employed as well. The user interface 131 is preferably interactive with the consumer, providing visual and/or auditory feedback regarding the consumer's selections. In addition, user interface 131 may provide additional stimulation to the customer in the form of questions that may be answered and opportunities to change selections. It is anticipated that the user interface 131 may also provide consumers an opportunity to test their knowledge and/or skill in return for a greater product portion and/or additional toppings.

User interface 131 may also preferably configured to provide a means for the customer to tender payment for the vended product, such as with a credit/debit card reader 135. Alternatively, a customer payment device is separate from the user interface 131. Other payment systems include, but are not limited to, bill acceptors, coin acceptors, token acceptors, credit card scanners, ID and password input devices, retinal scanners, fingerprint scanners, devices that communicate with the customer's cellular phone, and any other suitable form of payment technology. User interface 131 is in electronic communication with computer 90, which provides signals to operate robotic arm 75, servo motor 107, lights 83, speaker 68, and possibly other activatable components of the dispensing device 61.

As can be seen from the user interface 131 of FIG. 7, a touch screen panel 133 is provided in which a first frozen confectionary selection can be made from among a first group of frozen confectionary selections 135, 137, 139, each of which may represent a different type and/or flavor (or combinations of types and/or flavors) of frozen confectionary such as ice cream. The user can also select one or more toppings from a first group of topping choices 141, 143, 145, 147, 149, 151, 153, each of which may represent a single topping type and/or flavor (such as chocolate syrup, caramel syrup, various nuts, various candies, granola, etc.) or a combination of such toppings. A second group of topping selections 155, 157, 159 may also be provided to enable the user to specify multiple layers of frozen confectionaries and toppings as desired. Optionally, mixing of the dispensed ingredients may be accomplished with mixing assembly, which may be in electronic communication with computer 90. In further embodiments, user interface 131 may allow the user to select the size of receptacle 117 and/or determine whether the food they receive, in the case of a frozen yogurt, is layered or blended as it enters receptacle 117.

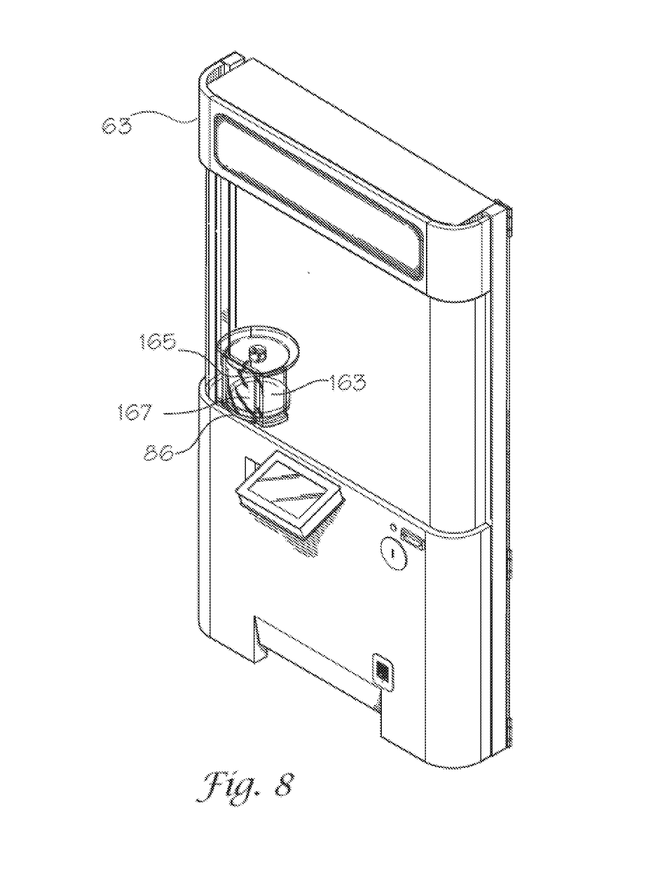

Referring to FIG. 8, a tilted view of facing 161 of dispensing device 61 is provided. In a preferred embodiment, facing 161 includes product delivery port 86, which includes an internal door 163 operable by computer 90 that separates the interior 65 of the vending machine 10 from the exterior. Internal door 62 functions to ensure a sanitary barrier between the interior 65 and exterior of dispensing device 61 and prevents customers from accessing and potentially contaminating interior 65 of dispensing device 61. An external door 165, may be provided to enable the customer to access the assembled product. Doors 163 and 165 define an intermediate surface 167 to which the assembled product is delivered by robotic arm 75. Doors 163 and 165 may be interlocked in a way that prevents both doors from being open at any point in time, which prevents unauthorized physical access to interior 65 of dispensing device 61.

In one preferred embodiment, dispensing device 61 of the present disclosure is capable of providing at least nine different ice cream or frozen yogurt, or any other foodstuff known to those of skill in the art, flavors and at least six different toppings. The order of the addition of the different flavors and the different toppings may be controllable by the customer. Examples of ice cream flavors that may be supplied include but are not limited to cotton candy, cappuccino, strawberry, chocolate, butter pecan, vanilla, banana ripple, cool mint, and cake batter. However, it is understood that more or less flavors as well as different flavors, as known to those of skill in the art, are within the scope of this disclosure. Each ice cream flavor may be supplied as a pre-formulated product or as a base wherein the flavorants are added at the time of selection by the customer. It will be understood that the method in which the ice cream is produced, formulated, and dispensed may be implemented in various ways. For example, ice cream may either be mixed and frozen fresh by dispensing device 61 or made offsite and delivered to dispensing device 61. Any suitable automated method for dispensing the ice cream or other frozen confectionary may be employed.

Examples of toppings that may be dispensed include but are not limited to hard candies such as M&M's®; soft candies such as Gummi Bears®, fruits such as raisins, dried pineapple or cherries; nuts, sauces, syrups, cookie crumbs, cookie dough, granola, or other liquid and/or solid based topping. In addition to their use as toppings, the toppings may be admixed as an admixture into any selected ice cream flavor to create an ice cream admixture. For example, blending of cookie crumbs or chocolate syrup into vanilla ice cream by the vending machine could provide an ice cream admixture.

In one hypothetical scenario, for each serving of ice cream there may be up to three different choices of ice cream selected and three different toppings, with each topping chosen from six available toppings. In this scenario, there would be over 5,000 distinct possible combinations selectable by the user.

In addition to the ability to provide a highly customized product, another element of a preferred embodiment is the provision of an auditory and/or visually stimulating experience for the customer, such as with dynamic or interactive control as described herein. Accordingly, an element of the present disclosure is that at least a significant portion of the preparation of the customized product is visible to the customer. Visual access to the preparation of the customized product can be achieved by the use of transparent conveyances, transparent storage containers, and visual contact with interior portions of dispensing device 61 through such means as, for example, transparent panels, wire grids, television monitors, or the like. Furthermore, it is anticipated that the visible interior portions of dispensing device 61 provide visual stimulation through motion of at least the robotic arm 75, movement of the toppings, and movement of the product receptacle 117. In a preferred embodiment, dispensing device 61 of the present disclosure may provide additional stimulation by allowing enhanced interaction with the customer through user interface 79 or 131, wherein in addition to receiving commands from the customer, user interface 79 or 131 may allow at least partial interactive control of the product assembly/dispensing process. In yet another preferred embodiment, user interface 79 or 131 may provide the customer with additional stimulation and interaction by providing opportunities for the customer to exhibit mental or physical dexterity prior to or concurrent with the assembly of the product, with rewards for success in exhibiting such mental or physical dexterity.

While the foregoing description has been directed toward the dispensing of frozen confectionary based products, it will be understood that the scope of the present disclosure encompasses the delivery of other customizable products to a customer in a visually and/or aurally stimulating manner, perhaps in a dynamically interactive manner. For example, a vending machine may be configured to assemble and dispense hot beverages (such as coffee, tea and cocoa). In the example of a coffee vending machine, a specific coffee type (i.e., dark roast, espresso, decaffeinated, etc.) is combined with additives such as whipped cream topping, chocolate flakes, sugar, creamers, spices, flavors of various kinds, etc. to provide a customized product. Customer performance related benefits may be available as well, such as the provision of more of a topping for a certain performance level or other dynamically interactive feature. As a further example of customizable products suitable the disclosure, pre-manufactured crayons could be assembled in accordance with the desires of a customer. For this product, the customer is able to select a specific set of colors that will comprise the assembled crayon package (i.e., 2 red and 3 blue in a package of 5 crayons, or which 8 of 15 colors are provided, etc.). In addition, the device may provide non-alcoholic or alcoholic drinks where consumers may mix the drink ingredients and/or alcohol types to create unique creations, including “slushy” type drinks.

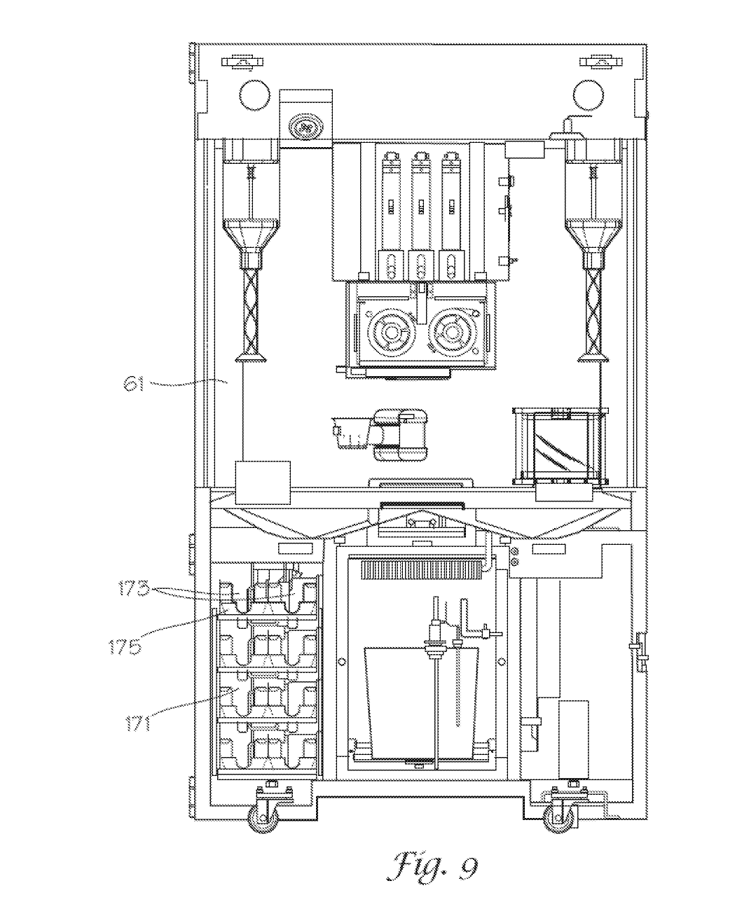

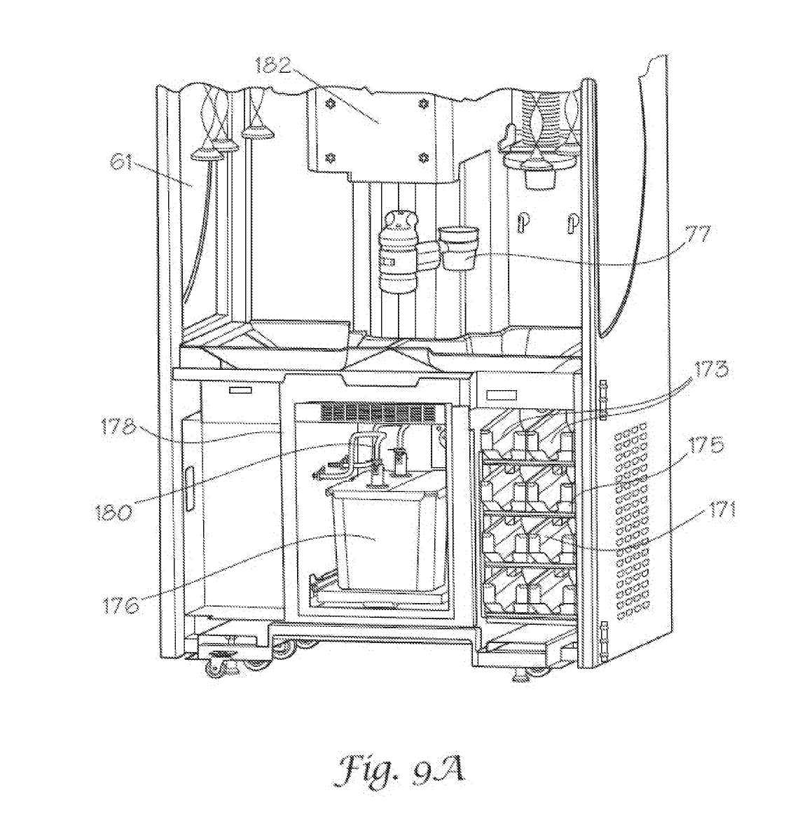

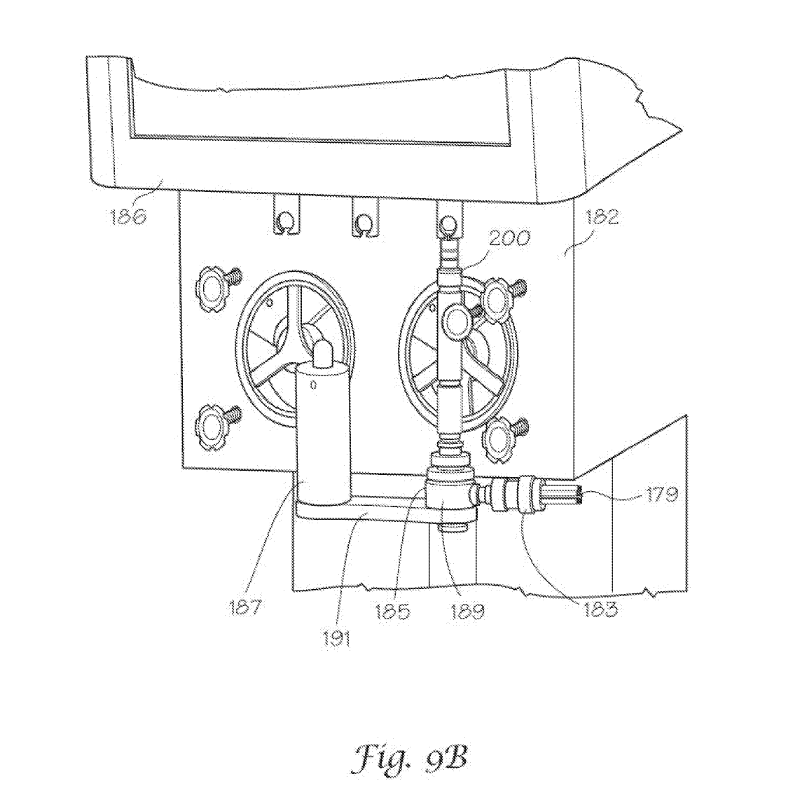

In a further embodiment, shown at FIG. 9, a dispensing device 61 may contain a multi-flavor injection system 171. This system may be used to allow consumers to layer products in receptacle 117, such as, for purposes of example only and not intended to be limiting, a layer of chocolate with a layer of vanilla above the chocolate with an uppermost layer of banana ripple. This may be accomplished by synchronized pumps providing flavors singly or in combinations of two or more flavors with the pumps controlled by computer 90 as the consumer directs from interface 131. Toppings may be interspersed with or between these layers in various embodiments. Alternatively, multi-flavor injection system 171 may allow consumers to mix flavors to create new flavors, such as, for purposes of example only and not intended to be limiting, banana ripple strawberry. Indeed, in a further embodiment, combined flavors may be blended and then layered to form separate layers of various blended flavors such as, for purposes of example only and not intended to be limiting, a layer comprising cool mint/cake batter underneath a layer of chocolate/strawberry/cappuccino underneath a layer of butter pecan/vanilla. In one embodiment, a single type of yogurt, such as vanilla, for purposes of example only and not intended to be limiting, may be used with various flavorings injected in series or parallel to the yogurt to create new flavors. While certain numbers of flavors are discussed, the numbers are not considered limiting as more or less numbers of flavors may be combined in various combinations through this disclosure.

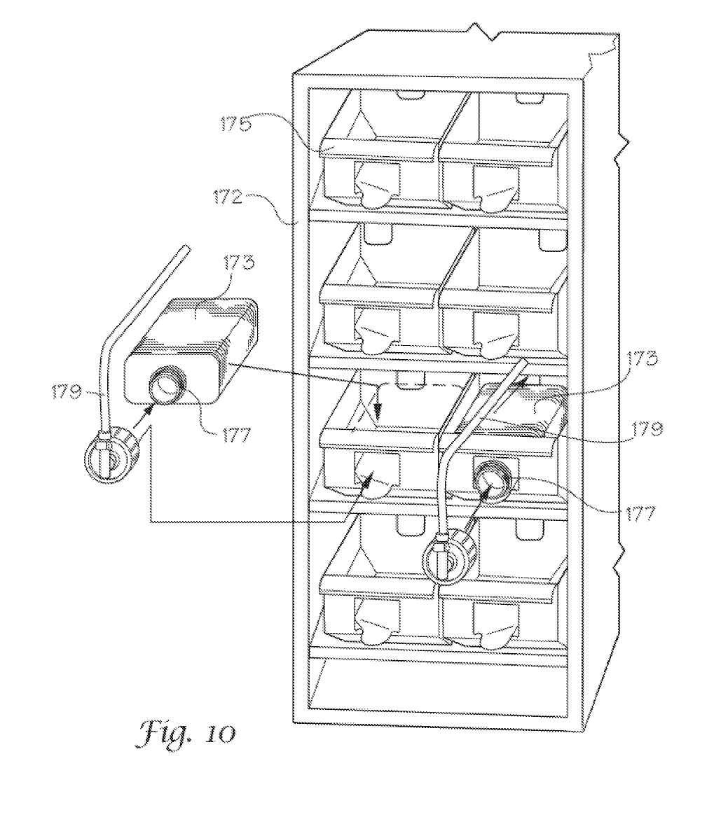

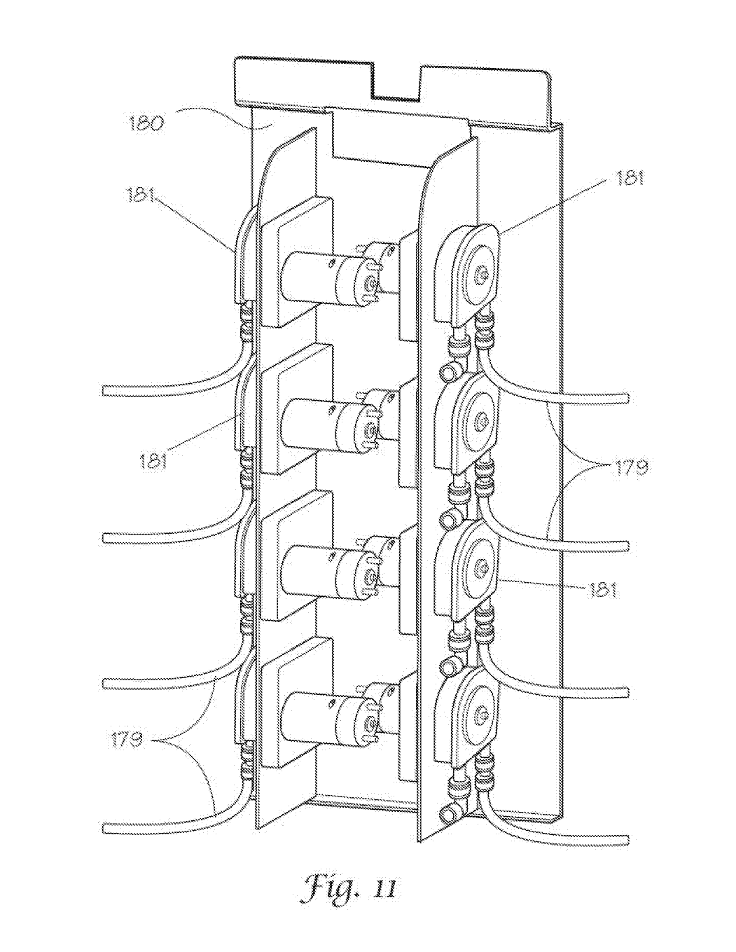

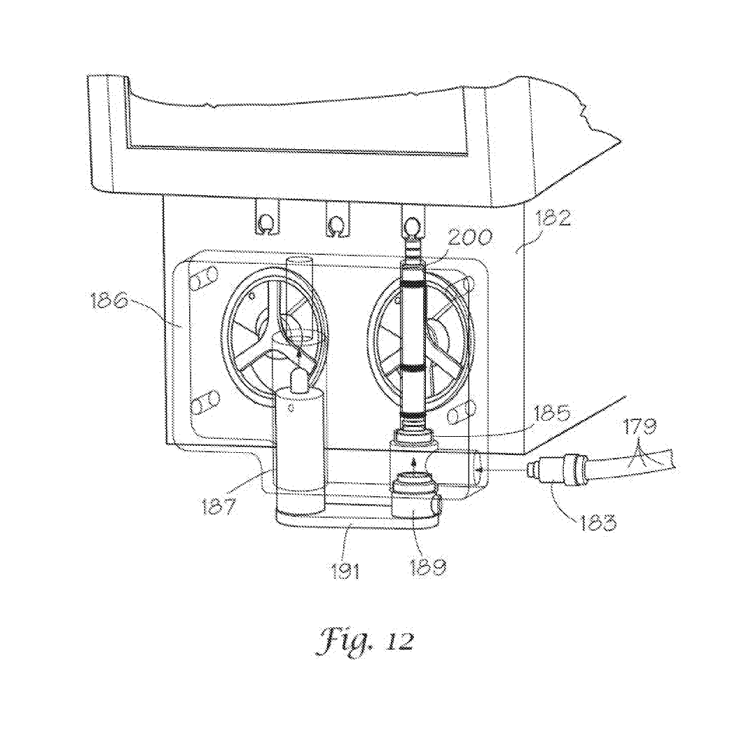

As FIG. 9 illustrates, multi-flavor injection system 171, in one embodiment, may comprise flavor containers 173 as part of ingredient assembly 172, e.g., bags of flavors, but the disclosure is not so limited and other food stuffs in various containers that may be contained in and processed by multi-flavor injection system 171 are with the scope of this disclosure, residing inside dispensing device 61 in receptacles 175. Flavor containers 173 may have apertures 177, see FIG. 10, whereby flavor containers 173 may be connected to hoses 179, or via other means known to those of skill in the art, to transport the contents of flavor containers 173 from receptacles 175 to pumps 181, pump 181 in one instance may be a peristaltic pump, or other pump as known to those of skill in the art at pump assembly 180, see FIG. 11. Pump 181 may be operated by a circuit, not shown, and may run at different speeds such as pulses from 20% to 100% of the pumps full speed, which may be as high as 55 RPM. While FIG. 11 shows a one pump per flavor ratio, fewer or more pumps are within the scope of this invention. Indeed, a single pump with multiple chambers may be used to deliver flavors from flavor containers 173 to the consumer. Once at pumps 181, hoses 179 are introduced into dispensing unit 183. The flavors may be injected simultaneously or separately into a blend head 185, see FIG. 12, a partially disassembled view of blend head assembly 186, depending on activation of pumps 181 either separately or jointly, based on the favor selection(s) by the consumer. A blend head motor 187, supported by motor base 191, may be incorporated to assist with moving flavors through flavor injection head 189 into blend head 185 and then out to dispensing station 121, see FIG. 3A. In one instance, one flavor is allotted per hose 179 and runs to blend head 185. Blend head 185 allows the flavors to inter the blend head 185 separately, in groups, or all simultaneously, depending on the flavor(s) selected by the consumer, delivery of which is controlled via pump(s) 181. In a further embodiment, only one type of yogurt may be introduced into blend head 185 with hose(s) 179 introducing various flavors to flavor the yogurt. Thus, only one base type of yogurt would be needed in multi-flavor injection system 171. However, this single flavor could be modified into thousands of different combinations via hoses 179 injecting flavors singly, in groups, or simultaneously. It is also within the scope of this disclosure that a consumer could control portions of the flavors injected. For purposes of example only and not intended to be limiting, a ⅓ portion chocolate, 1 portion strawberry, ½ portion vanilla combination of flavors could be introduced to the base yogurt, instead of a 1 portion chocolate, 1 portion strawberry, 1 portion vanilla combination, to create distinct “flavor levels” based on not only different flavors being introduced but different amounts of the flavors being introduced to the base yogurt.

FIG. 9A shows a close-up, cut-away front view of one embodiment of the device. In this embodiment, yogurt, not shown, may be stored in mix container 176 inside a refrigerator 178. In the example of yogurt, refrigerator 178 may maintain a temperature of between 36 to 41 degrees Fahrenheit. The yogurt, or other foodstuff, may be pumped from mix container 176 via periscopic pump 180 to freezing cylinder 182. Freezing cylinder 182 may freeze the yogurt, or other foodstuff, and may maintain a temperature of between 14 to 25 degrees Fahrenheit, depending on the freezing point of the mixture supplied from mix container 176.

FIG. 9B shows a close up view of blend head assembly 186 where, once the yogurt or other food stuff is frozen in freezing cylinder 182, and after the consumer chooses a flavor, spigot 200 may open and allow the yogurt, or other foodstuff, to run into blend head 185 where the yogurt may be flavored by one, groups of, or all flavors introduced via hoses 179 and mixed. Once mixed, the yogurt will exit blend head 185 into receptacle 77 (see FIG. 9A).

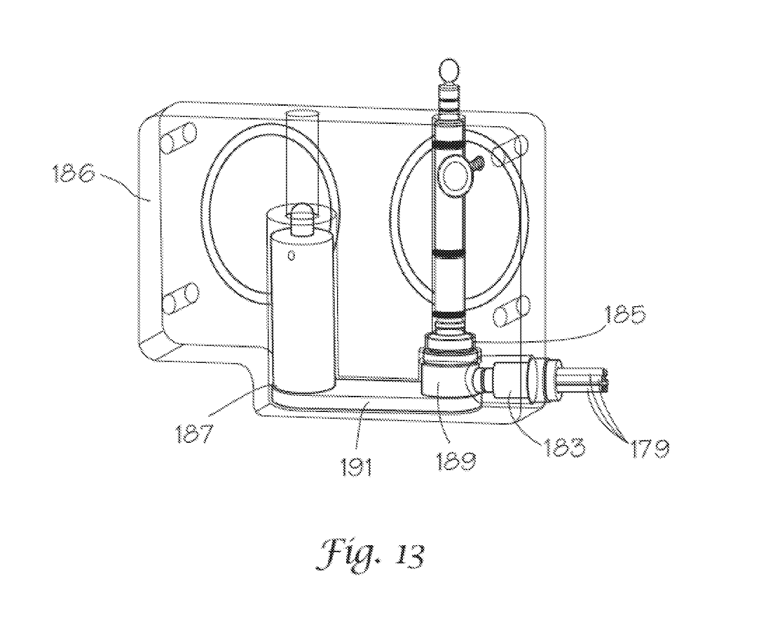

FIG. 13 shows a wire diagram view of an assembled blend head assembly 186.

Exemplary embodiments of the disclosure will now be illustrated in the following examples, which are not to be construed as encompassing all possible embodiments.

### EXAMPLE 1

Ice Cream/Toppings Treat

A dispensing device 61 of the present disclosure possesses at least nine separate ice cream flavors and at least six different toppings. Each topping is contained in a separate transparent toppings container 71 that is placed directly over a transparent, multi-bend plastic tube or conductor 73. Adjacent the bottom of each toppings container 71, may be an auger, paddle wheel, or other measuring/dispensing mechanism. Dispensing device 61 is activated by a consumer engaging user interface 131. User interface 131 then asks the customer to select the style of the receptacle 117, such as edible or nonedible or specifically shaped, generically shaped, etc. Next, interface 131 inquires as to the amount or size of ice cream serving the consumer wants placed in the receptacle 117. User interface 131 then inquires as to whether the ice cream should be blended or layered as it enters receptacle 117, as discussed supra. User interface 131 then inquires as to the toppings the consumer wants added to the ice cream as well as the order of placement of the toppings. User interface 131 then asks the consumer to provide payment for the selected ice cream product.

Robotic arm 75 then acquires product receptacle 117 from a product receptacle dispenser 66 and places product receptacle 117 under ice cream dispenser 125. Next robotic arm 75 moves the product receptacle 117 to a position below outlet 103 of conductor 73 that connects to a selected toppings container 71. Servo motor 107 activates to deliver a measured amount of the first selected topping to the top of conductor 73, whereupon the selected topping is transported by gravity atop the ice cream in the product receptacle 117. After delivery of the first topping is complete, the robotic arm 75 may move product receptacle 117 back to ice cream dispenser 125 (depending on the order of ice cream and toppings selected by the consumer) and may be followed by positioning receptacle 117 below outlet 103 of the second selected toppings container 71, etc., until the product as specified by the customer is fully assembled. The robotic arm 75 then places the filled product receptacle 117 on surface 167 at product delivery port 86 where the product is then transported through internal door 163 and external door 165 to be retrieved by the customer.

### EXAMPLE 2

Ice Cream/Toppings Treat

A dispensing device 61 of the present disclosure possesses one ice cream flavor and five different toppings. Each topping is contained in a separate transparent toppings container that is placed directly over a transparent, coiled glass tube or conductor 73. The bottom of each toppings container may possesses an auger or paddle wheel. Dispensing device 61 is activated by a customer inserting a token. The user interface 131 then asks the customer to select the topping that will be on top, in the middle and on the lowest level. In this example, the ice cream treat that is made will possess a total of six (6) layers; with ice cream in layers 1, 3, and 5 (from the bottom to top) and toppings in layers 2, 4, and 6. Robotic arm 75 then acquires a product receptacle 117 from a product receptacle dispensing station 66 and places the product receptacle 117 under dispensing station 131. Next, robotic arm 75 then moves the product receptacle to a position below the outlet 103 of transparent conductor 73 that connects to the selected toppings container. A measured amount of the first selected topping is provided to the top of the transparent conductor 73, whereupon the selected topping is transported by gravity to the top of the ice cream in the product receptacle 117. After delivery of the first topping is complete, the robotic arm 75 moves the product receptacle 117 back to dispensing station 131, followed by positioning below the outlet 103 of the second selected toppings transparent conductor 73, etc., until the product is fully assembled. The robotic arm 75 then places the filled product receptacle 117 at surface 167 at product delivery port 86 where the product will be transported through internal door 163 and external door 165 where it can be retrieved by the customer.

### EXAMPLE 3

Crushed Ice Treat

A dispensing device 61 of the present disclosure may possess ice that is crushed and/or generated and multiple, for purposes of example only and not intended to be limiting six (6), different liquid toppings (e.g., lemon-lime, orange, banana, watermelon, cherry, and grape, etc.). Each topping is contained in a separate transparent toppings container 71 that is placed directly over a transparent, coiled glass tube conductor 73. The bottom of each toppings container 71 may possess a valve, not shown, for controlling the amount of topping that will be dispensed. Dispensing device 61 may be activated by a customer inserting a token. The user interface touch screen panel 131 then asks the customer to select a number of toppings. Robotic arm 75 then acquires a product receptacle 117 from a product receptacle dispensing station 66 and places the product receptacle 117 below the ice dispenser 121. Next, robotic arm 75 moves the product receptacle 117 to a position below outlet 103 of the transparent conductor 73 that connects to the selected toppings container 71. The valve is then activated to deliver a measured amount of the first selected topping to the top of the transparent conductor 73, whereupon the selected topping is transported by gravity to the top of the crushed ice in the product receptacle 117. After delivery of the first topping is complete, robotic arm 75 moves the product receptacle 117 to the next selected topping dispensing station 121 and then again until the product is fully assembled. Robotic arm 75 then moves the filled product receptacle 1117 to port 86 where it is transported through the doors 163 and 165 where it can be retrieved by the customer.

### EXAMPLE 4

Espresso/Cappuccino/Coffee

A dispensing device 61 of the present disclosure possesses espresso/cappuccino/coffee made real time by an existing espresso/cappuccino/coffee machine, steamed or frozen/slurry milk and multiple liquid flavoring options/toppings and other various and sundry toppings. Each flavoring and the milk are contained in separate transparent containers 71 that are placed directly over a transparent, coiled glass tube conductor 73. The bottom of each container 71 may include a valve for controlling the amount of flavoring/milk that will be dispensed. A customer inserting a token activates dispensing device 61. The user interface 131 then allows the customer to select the type of coffee, the flavor, the milk (slurry or steamed) as well as other topping options that may be available such as whipped cream, chocolate powder, sprinkles, cinnamon, and the like. Robotic arm 75 then acquires a product receptacle 117 from a product receptacle dispenser 66 and places the product receptacle 66 below the espresso/cappuccino/coffee dispenser 121, which receives the freshly made espresso/cappuccino/coffee. Robotic arm 75 then moves the product receptacle 117 to a position below outlet 103 of transparent conductor 73 that connects to the selected flavor container 71. The valve is then activated to deliver a measured amount of the selected flavor to the top of the transparent conductor 73, whereupon the selected flavoring is transported by gravity to mix with the espresso/cappuccino/coffee in the product receptacle 117. After delivery of the flavoring, robotic arm 75 moves the product receptacle 117 to the steamed or slurry milk and then other selected toppings until the product is fully assembled. Robotic arm 75 then places the filled product receptacle 117 at port 86 where it is transported through the doors 163 and 165 where the customer can retrieve it.

Although frozen confectionary type products have been discussed primarily above, it will be understood by immediately preceding description that coffee based beverages could also be provided, whether hot or cold, along with various other products, such as providing the ability to decorate a cake with a selected design and watching the decoration take place on top of a selected flavor of cake, or providing the ability to assemble an assortment of candies (such as multiple flavors of jelly beans). Additionally, while the robotic arm 75 principally moves the product receptacle 117, it could also be utilized to move at least an outlet of a dispenser such as of ice cream, toppings, etc. relative to a product receptacle 117 while allowing viewing of at least a portion of the process by the customer.

Unless specifically stated, terms and phrases used in this document, and variations thereof, unless otherwise expressly stated, should be construed as open ended as opposed to limiting. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise.

Furthermore, although items, elements or components of the disclosure may be described or claimed in the singular, the plural is contemplated to be within the scope thereof unless limitation to the singular is explicitly stated. The presence of broadening words and phrases such as “one or more,” “at least,” “but not limited to” or other like phrases in some instances shall not be read to mean that the narrower case is intended or required in instances where such broadening phrases may be absent.

While the present subject matter has been described in detail with respect to specific exemplary embodiments and methods thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art using the teachings disclosed herein.

What is claimed is:

1. A confectionary entertainment station comprising:
a product dispensing area, which includes at least one movable container holder for interacting with a container;
wherein the movable container holder may rotate and turn the container as well as extend, retract, raise, and lower the container at least vertically and horizontally within the product dispensing area;
a multiple flavor reservoir, wherein the multiple flavor reservoir has pumps associated with individual flavors, wherein the pumps operate simultaneously or separately from one another;
at least one flavor dispenser for introducing at least one flavor into the container;
a user interface that allows a user to configure flavors for introduction into the container;
wherein the user interface permits a user to layer the flavors, blend the flavors, or both blend and layer flavors;
at least one topping dispenser for placing toppings into the container; and
at least one transparent viewing window.

2. The confectionary entertainment station of claim 1, further comprising a payment acceptor.

3. The confectionary entertainment station of claim 2, wherein the payment acceptor determines a price for the confectionary after the user selects the flavors and toppings added to the container.

4. The confectionary entertainment station of claim 1, further comprising a container dispenser.

5. The confectionary entertainment station of claim 1, further comprising a safety alert system wherein the safety alert system provides information to the user when the user's position impedes function of the entertainment station.

6. The confectionary entertainment station of claim 5, wherein the safety alert system may halt or reverse product delivery until the user complies with the information provided by the safety alert system.

7. The confectionary entertainment station of claim 1, wherein at least one topping dispenser is transparent.

8. The confectionary entertainment station of claim 1, wherein at least the product dispensing area comprises UV lights.

9. The confectionary entertainment station of claim 1, wherein the at least one topping dispenser includes at least one retarder to slow a flow of topping within the at least one topping dispenser as it is delivered to the container.

10. The confectionary entertainment station of claim 1, wherein the confectionary entertainment system includes speakers that provide sounds while the user uses the confectionary entertainment system.

11. The confectionary entertainment station of claim 1, wherein the user interface poses questions to the user wherein correct answers may provide more toppings or flavors into the container.

12. The confectionary entertainment station of claim 1, wherein the user may insert toppings and flavors into the container in an order selected by the user.

13. The confectionary entertainment station of claim 1, wherein the user interface allows the user to control movement of the at least one movable container holder.
